(19) United States
(12) Patent Application Publication
(10) Pub. No.: US 2015/0085478 A1
(43) Pub. Date: Mar. 26, 2015

(54) CAP ATTACHMENT FOR A RADIO ANTENNA

(71) Applicants: Walter Richmond, Hammond, LA (US); LaShaun Nicholson, Hammond, LA (US)

(72) Inventors: Walter Richmond, Hammond, LA (US); LaShaun Nicholson, Hammond, LA (US)

(21) Appl. No.: 14/034,791

(22) Filed: Sep. 24, 2013

(51) Int. Cl. F21L 4/08; F21V 33/00

(52) U.S. Cl. CPC F21L 4/08; F21V 33/00
USPC 362/183

(57) ABSTRACT

A cap that's installed onto a radio antenna, in particular CB radio antenna. The cap includes an opening that inserts onto a receiving end of an antenna and includes a means to illuminate the cap that is powered through the use of solar energy. The cap also includes a small solar panel on top of the cap and a body portion that illuminates during the nighttime. The illuminated cap creates a clear indication that a CB radio is installed on a particular vehicle when traveling at night.

### BACKGROUND OF THE INVENTION

1. Field of Invention

The present invention relates to a cap for a radio antenna that includes a means to illuminate the cap as a decorative feature.

2. Description of Related Art

Many individuals use Citizen Band (CB) radios, as a means of entertainment during their leisure time. Further CB radios are used by over-the-road truckers to communicate aspects of the highway and as a means to entertain and communicate with others while driving over the road. The CB radio is usually installed in a truck and includes a particular radio antenna extending from the truck in order to transmit and receive radio waves over various CB frequencies. The typical antenna is a metal antenna that extends and may include a small cap at the top of the antenna. One way to maintain the popularity of CB radios is to include various accessories with the radios such as decorative accessories or accessories related to the console ride for the radio. These accessories provide further features that help promote the interests and use of CB radios.

### SUMMARY OF INVENTION

The present invention relates to a cap that's installed onto a radio antenna, in particular CB radio antenna. The cap includes an opening that inserts onto a receiving end of an antenna and includes a means to illuminate the cap that is powered through the use of solar energy. The cap also includes a small solar panel on top of the cap and a body portion that illuminates during the nighttime. The illuminated cap creates a clear indication that a CB radio is installed on a particular vehicle when traveling at night.

### BRIEF DESCRIPTION OF DRAWINGS

FIG. 1 depicts a cap for a radio antenna in accordance with the present invention.

### DETAILED DESCRIPTION

The present invention relates to a cap that's installed onto a radio antenna, where the cap illuminates during nighttime hours. During the day the cap is charged through the use of a small solar panel that's placed on top of the cap and receives sufficient energy to illuminate the cap during nighttime hours.

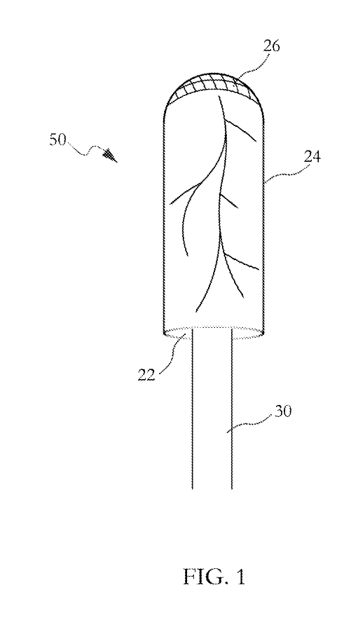

In reference to FIG. 1, a cap 50 is depicted. The cap 50 is installed onto an antenna 30. An opening 22 is provided for the installation of the cap 50 onto the antenna 30. The cap 50 includes a solar panel 26 over the top surface of the cap 50. The body portion 24 of the cap 50 may include a decorative arrangement that is illuminated through a light source within the cap. Further the illumination is around the outer perimeter of the cap which is powered by energy provided through the solar panel 26. Although not shown the cap may include a small battery which is charged through the solar panel 26 as a means to store power for later usage.

The use of the cap as presented with the present invention helps to provide a unique accessory for CB radios. In one particular embodiment, the cap may be up to 4 to 5 inches in length. The present invention actually creates a decorative light for the antenna and helps to provide a novel feature that can be attached to CB radios used by truck drivers or other popular vehicles such as police vehicles.

1. A cap for a radio antenna comprising:
an opening, where the opening provides a means to insert the cap onto the radio antenna;
a solar panel on the top of the cap, where the solar panel provides the energy source; and
a body portion, extending between the opening and the top of the cap.

2. The cap for radio antenna according to claim 1, where the body portion is unable to illuminate in a dark environment.

3. The cap for a radio antenna according to claim 1 further including a battery to store energy for illuminating the body portion and a sensor which detects a dark environment to activate illumination of the body portion.
